(19) United States
(12) Patent Application Publication
(10) Pub. No.: US 2007/0267832 A1
(43) Pub. Date: Nov. 22, 2007

(54) Cleaning cart

(76) Inventor: Evgueni Denissov, Carleton Place (CA)

Correspondence Address: LITMAN LAW OFFICES, LTD., P.O. BOX 15035, CRYSTAL CITY STATION, ARLINGTON, VA, 22215, US

(21) Appl. No.: 11/797,718

(22) Filed: May 7, 2007

Related U.S. Application Data
(60) Provisional application No. 60/800,395, filed on May 16, 2006.

(51) Int. Cl. B62B 3/00

(52) U.S. Cl. 280/47.35

(57) ABSTRACT

A universal cleaning cart includes a wheeled platform, which platform supports a trash receptacle, snap-in units for holding brooms, mops, etc., receptacles for holding supplies, an area for supporting a vacuum cleaner and a support shelf for housing a wheeled bucket and wringer system. The bucket and wringer system are easily removable from the support shelf without lifting.

### CROSS-REFERENCE TO RELATED APPLICATION

This application claims the benefit of U.S. Provisional Patent Application Ser. No. 60/800,395, filed May 16, 2006.

### BACKGROUND OF THE INVENTION

1. Field of the Invention

The present invention generally relates to transporting devices. More specifically, the invention is drawn to a mobile maintenance cart adapted to transport a waste container and cleaning implements.

2. Description of the Related Art

Some industrial plants and commercial establishments such as hotels, office buildings, restaurants, etc. often require cleaning maintenance at off times when customers and workers are not in full attendance. The cleaning must be accomplished in an efficient manner so that the establishment or plant can be up and running at peak business hours. Mobile cleaning carts are currently utilized by cleaning personnel to expedite the cleaning process. These carts usually comprise wheeled platforms configured to support at least one trash receptacle. Plural compartments or trays, mounted on the platforms, are designed to contain bottles of cleaning solutions and other paraphernalia that may be needed to complete the cleaning process. Pertinent related art samples of the above-mentioned carts are cited and identified in the accompanying IDS. However, none of the cited and identified related art discloses a portable cleaning cart as will subsequently be described and claimed in the instant invention.

### SUMMARY OF THE INVENTION

The universal cleaning cart of the present invention comprises a wheeled platform, which platform includes a unique trash receptacle, snap-in units for holding brooms, mops, etc., receptacles for holding supplies, an area for supporting a vacuum cleaner and a support shelf for housing a wheeled bucket and wringer system. The bucket is adapted to contain water for cleaning a floor. The bucket and wringer system are easily removable from the support shelf without lifting.

Accordingly, the instant invention presents a cleaning cart that contains all implements and supplies needed to accomplish the cleaning process. The invention provides for improved elements thereof in an arrangement for the purposes described that are inexpensive, dependable and fully effective in accomplishing their intended purposes.

A clear understanding of the present invention will become readily apparent upon further review of the following specification and drawings.

### BRIEF DESCRIPTION OF THE DRAWINGS

FIG. 1 is an environmental, perspective view of a cleaning cart according to the present invention.

FIG. 2 is a partial, rear view of a cleaning cart according to the present invention.

FIG. 3 is a partial, top view of a cleaning cart according to the present invention.

FIG. 4 is an exploded, perspective view of a wringer and bucket according to the present invention.

FIG. 5 is a sectional, side view of a first embodiment of a wringer according to the present invention.

FIG. 6 is a sectional, side view of a second embodiment of a wringer according to the present invention.

FIG. 7 is a perspective view of an auxiliary container according to the present invention.

Similar reference characters denote corresponding features consistently throughout the attached drawings.

### DETAILED DESCRIPTION OF THE PREFERRED EMBODIMENTS

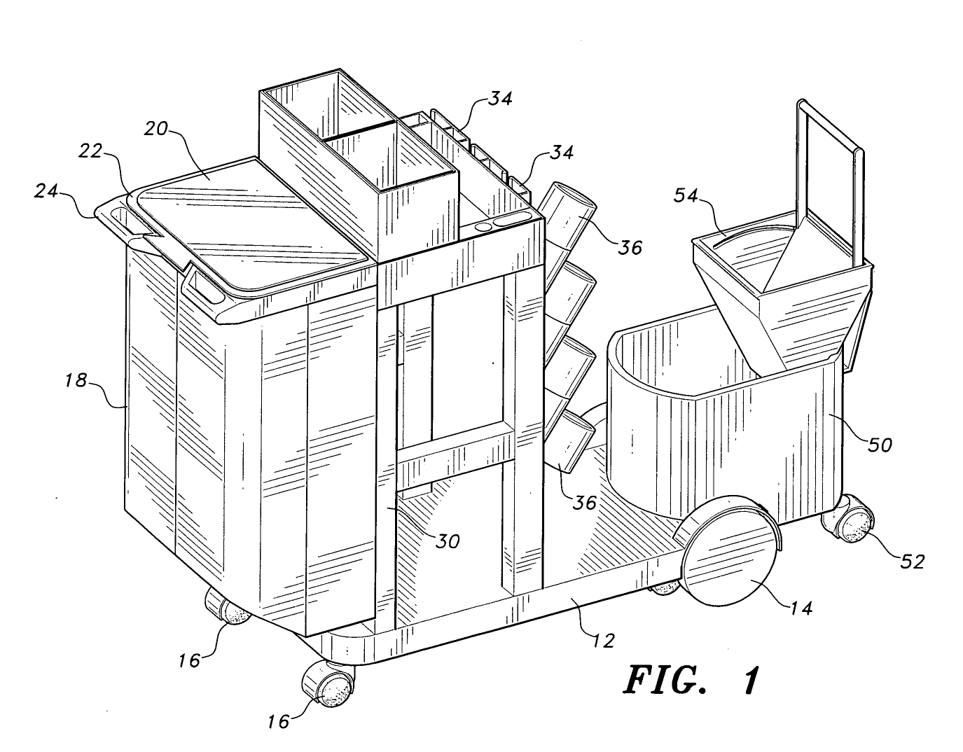

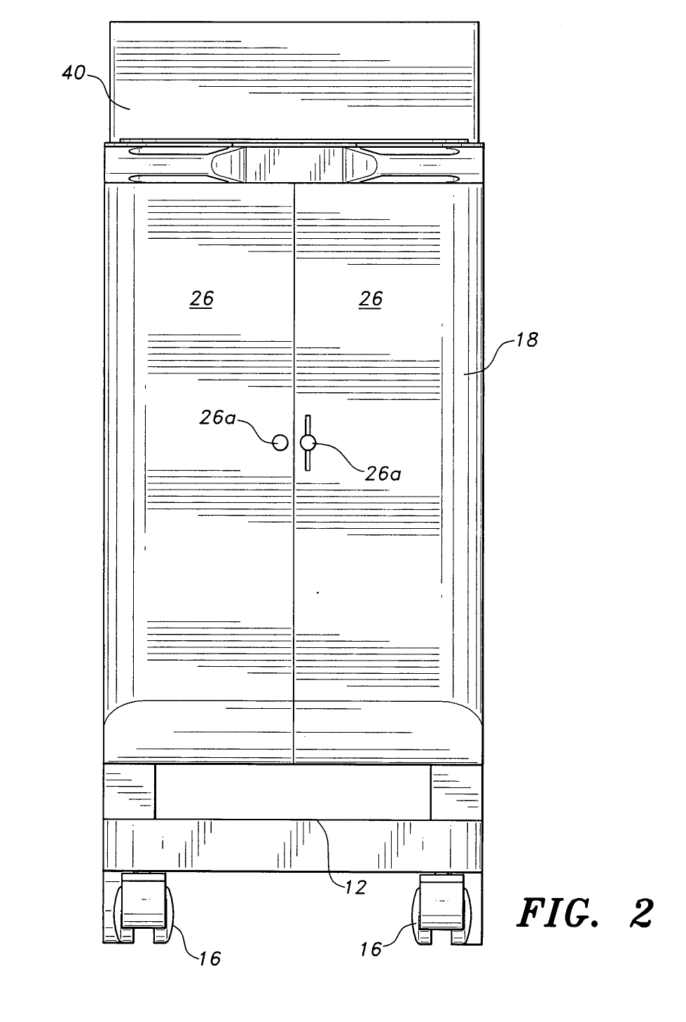

Attention is first directed to FIGS. 1-3 wherein the cleaning cart of the present invention is illustrated. The cart comprises a platform 12, which platform is mounted on two front wheels 14 and two rear wheels 16. The front wheels 14 are larger in size (8″) than rear wheels 16 (3″). Rear wheels 16 are pivotally mounted to the underside of platform 12. In contrast, front wheels 14 are mounted to the underside of the platform for axial rotation only and do not pivot. This arrangement allows the cart to have a high degree of maneuverability including the ability to easily traverse obstacles such as extension cords, thresholds and the like. The upper side of platform 12 provides an ample workspace area.

A trash or garbage receptacle 18 is positioned at the rear of platform 12. Trash receptacle 18 is fabricated from durable, dense plastic material and is provided with a lid to prevent inadvertent spills. A transparent plastic pocket 20 is disposed on top of the lid for the placement of work schedules and other important information. A removable metal frame 22 is utilized to secure a garbage bag placed in the receptacle. The upper end of trash receptacle 18 is encompassed by a handle 24, which handle is attached to a frame structure 30. A pair of doors 26 is attached to the front face of trash receptacle 18 to allow for easy removal of extremely heavy garbage bags, whereby the bags can be removed from the receptacle without tearing. Handles 26a are provided to facilitate opening and closing doors 26. Provision is made for removable shelves (not shown) to be positioned in trash receptacle 18 if desired.

The cart is equipped with a top shelf 32. Plural snap-in holders 34 are disposed around the perimeter of the shelf. Snap-in holders 34 are designed to hold implements such as brooms, dust mops, wet mops, etc. Receptacles 36 are supported on platform 12 and are adapted to house cleaning solution containers, spray bottles and the like. Opening 38 is adapted to retain a removable rod for holding paper towels. A main tray having rectangular containers 40 therein are disposed on the top shelf 32 and are adapted to be filled with any needed work supplies.

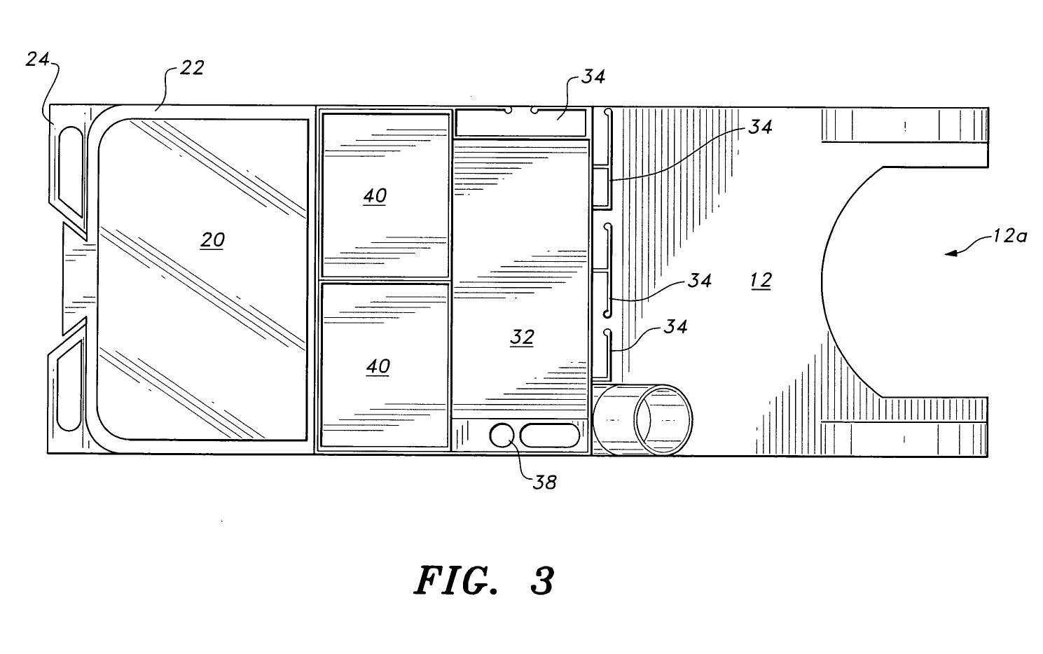

At its front end, platform 12 is designed with a cut-out portion 12a (FIG. 3). Cut-out portion 12a is adapted to receive a washing bucket or pail 50 therein. Bucket 50 is mounted on plural wheels 52 so that the bucket can be easily moved with the cart. A unique wringer system 54 is mounted on bucket 50. The bucket is available in two sizes. The smaller size is especially adapted for small business and household use.

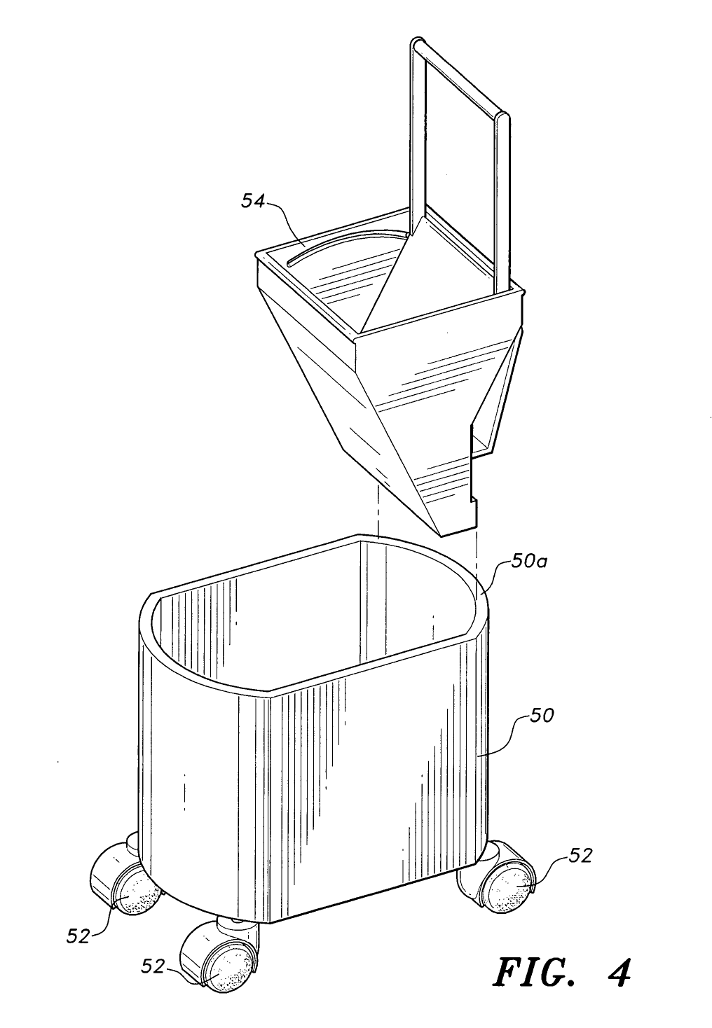

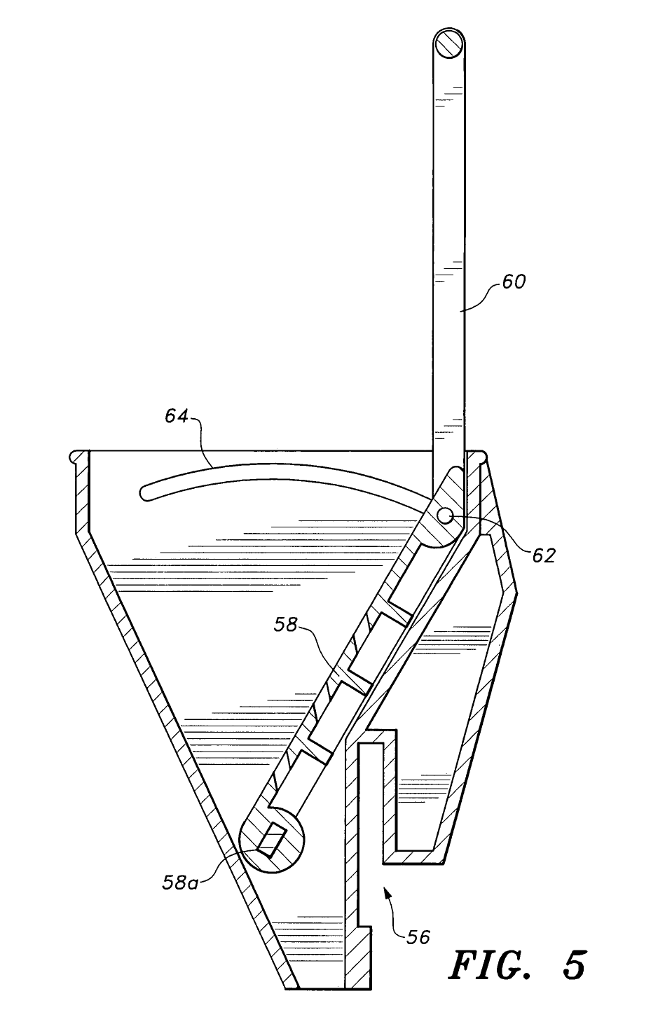

As best seen in FIGS. 4 and 5, wringer 54 comprises a notch 56 adapted to fit over the edge 50a of bucket 50. A wringer panel 58 is pivotally mounted on axis 58a. Handle 60 and rod 62 function to rotate panel 58 in groove 64 to extract water from a wet-mop (not shown) positioned adjacent panel 58.

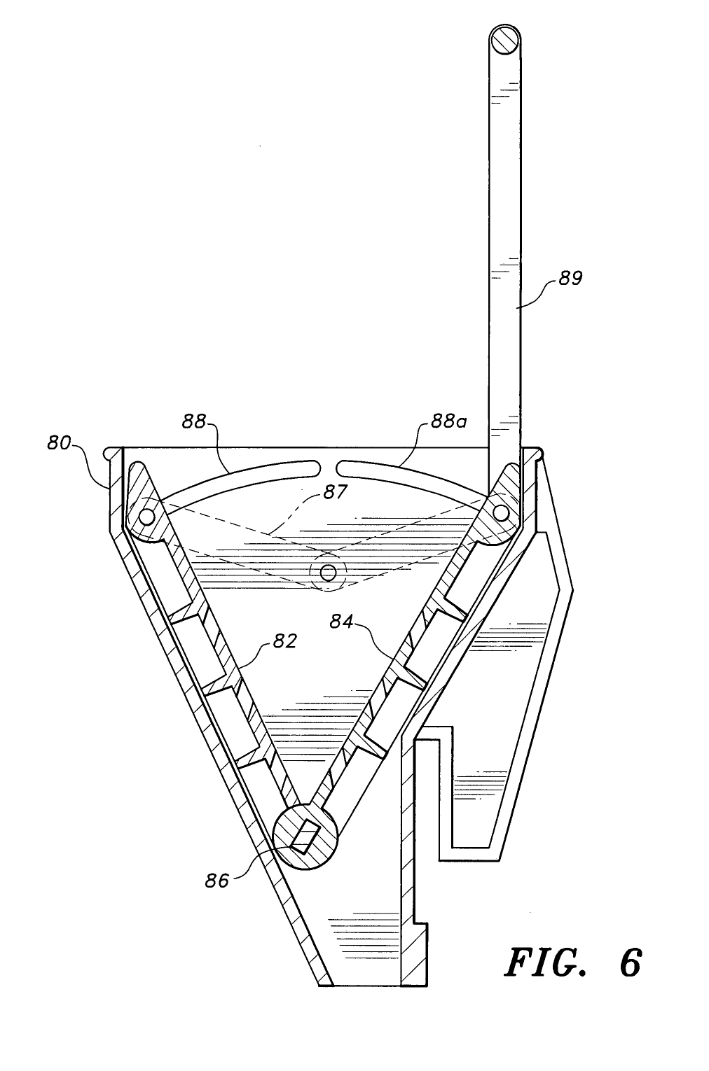

A second embodiment of the wringer system is shown at 80 (FIG. 6) and comprises a pair of wringer panels 82, 84 both pivotally mounted at their lower ends on a common axis 86. The upper end of panel 82 is rotated in groove 88. The upper end of panel 84 is rotated in groove 88a. A linkage system 87 (shown in phantom lines) functions to stabilize rotation. A handle 89 is utilized to provide grasping means to rotate the panels.

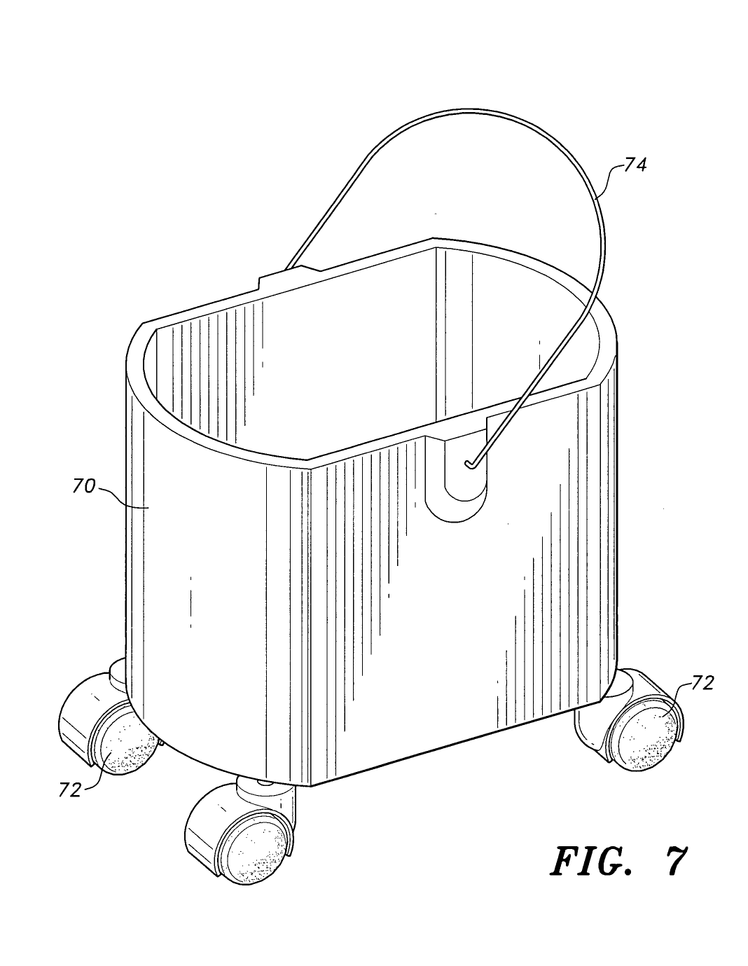

FIG. 7 illustrates an auxiliary garbage container 70 having wheels 72 thereon. Container 70 is equipped with a handle 74 to enhance manipulation. Container 70 is adapted to fit into the front of the cart.

It is to be understood that the present invention is not limited to the embodiments described above, but encompasses any and all embodiments within the scope of the following claims.

I claim:

1. A cleaning cart, comprising:
a platform, said platform having a front end and a rear end;
a first pair of wheels attached to said platform at said front end;
a second pair of wheels attached to said platform at said rear end;
an upper shelf supported on said platform adjacent said rear end;
a handle extending rearward from said upper shelf, said handle defining a central opening;
a cut-out portion formed in said platform at said front end; and
a bucket positioned in said cut-out portion.

2. The cleaning cart according to claim 1, including a trash receptacle positioned in said central opening.

3. The cleaning cart according to claim 1, wherein said first pair of wheels is larger in size than said second pair of wheels.

4. The cleaning cart according to claim 1, wherein plural wheels are affixed to said bucket.

5. The cleaning cart according to claim 1, including a mop wringer removably disposed on said bucket.

6. The cleaning cart according to claim 1, wherein said upper shelf has a perimeter and including an array of snap-in holders arranged around the perimeter of said upper shelf.

7. A cleaning cart, comprising:
a platform, said platform having a front end and a rear end;
a first pair of wheels attached to said platform at said front end;
a second pair of wheels pivotally attached to said platform at said rear end, wherein said first pair of wheels is larger in size than said second pair of wheels;
an upper shelf supported on said platform adjacent said rear end, said upper shelf having a perimeter;
a handle extending rearward from said upper shelf, said handle defining a central opening;
a trash receptacle disposed in said central opening;
a cut-out portion formed in said platform at said front end;
a bucket positioned in said cut-out portion, said bucket having an underside; and
a mop wringer removably disposed on said bucket.

8. The cleaning cart according to claim 7, wherein plural wheels are affixed to the underside of said bucket.

9. The cleaning cart according to claim 7, including an array of snap-in holders arranged around the perimeter of said upper shelf.

10. The cleaning cart according to claim 7, including an array of receptacles supported on said platform.

11. The cleaning cart according to claim 7, wherein said trash receptacle has a front face and including a pair of doors attached to said front face.

12. The cleaning cart according to claim 7 wherein said bucket has an edge and said mop wringer includes a notch for receiving said edge.

13. The cleaning cart according to claim 7, wherein said mop wringer comprises:
a pivoted, apertured wringer plate; and
a handle attached to said wringer plate for pivoting said wringer plate.

14. The cleaning cart according to claim 7, wherein said mop wringer comprises:
a pair of pivoted, apertured wringer plates; and
a handle attached to one of said pair of wringer plate plates for pivoting said pair of wringer plates.

15. A cleaning cart, comprising:
a platform, said platform having a front end and a rear end;
a first pair of wheels attached to said platform at said front end;
a second pair of wheels pivotally attached to said platform at said rear end, wherein said first pair of wheels is larger in size than said second pair of wheels;
an upper shelf supported on said platform adjacent said rear end, said upper shelf having a perimeter;
a handle extending rearward from said upper shelf, said handle defining a central opening;
a trash receptacle disposed in said central opening, said trash receptacle having a front face and a pair of doors mounted on said front face;
a cut-out portion formed in said platform at said front end;
a bucket positioned in said cut-out portion, said bucket having an edge and an underside; and
a mop wringer removably disposed on said bucket.

16. The cleaning cart according to claim 15, wherein plural wheels are affixed to the underside of said bucket.

17. The cleaning cart according to claim 15, including an array of snap-in holders arranged around the perimeter of said upper shelf and an array of receptacles supported on said platform.

18. The cleaning cart according to claim 15 wherein said mop wringer includes a notch for receiving said edge of said bucket.

19. The cleaning cart according to claim 18, wherein said mop wringer comprises:
a pivoted, apertured wringer plate; and
a handle attached to said wringer plate for pivoting said wringer plate.

20. The cleaning cart according to claim 18, wherein said mop wringer comprises:
a pair of pivoted, apertured wringer plates; and
a handle attached to one of said pair of wringer plate plates for pivoting said pair of wringer plates.
